(19) United States
(12) Patent Application Publication
(10) Pub. No.: US 2010/0011607 A1
(43) Pub. Date: Jan. 21, 2010

(54) Clothes dryer having fragrance supplying module

(76) Inventors: Min-Ji KIM, Changwon (KR); Sang-Hun BAE, Changwon (KR); Chul-Jin CHOI, Changwon (KR)

Correspondence Address: MCKENNA LONG & ALDRIDGE LLP, 1900 K STREET, NW, WASHINGTON, DC, 20006, US

(21) Appl. No.: 12/458,596

(22) Filed: Jul. 16, 2009

Related U.S. Application Data
(60) Provisional application No. 61/081,613, filed on Jul. 17, 2008.

(30) Foreign Application Priority Data
Jul. 17, 2008 (KR) 10-2008-0069727

(51) Int. Cl. F26B 19/00; F26B 11/02

(52) U.S. Cl. 34/60; 34/108

(57) ABSTRACT

A clothes dryer having a fragrance supplying module, comprises: a body that forms appearance of the clothes dryer; a drum rotatably installed in the body; and a front supporter for supporting the drum at a front side, wherein the fragrance supplying module for supplying fragrance into the drum is provided at the front supporter. The fragrance supplying module comprises a fragrance injection unit, a fragrance storage unit connected to the fragrance injection unit, a pump connected to the fragrance storage unit, and a nozzle connected to the pump by a tube, for lo spraying fragrance into the drum. Accordingly, a fragrant liquid stored in the fragrance storage unit can be easily sprayed into the drum.

### RELATED APPLICATION

The present disclosure relates to subject matter contained in priority Korean Application No. 10-2008-0069727, filed on Jul. 17, 2008, 2008 and U.S. Patent Application No. 61/081,613, filed on Jul. 17, 2008 which are herein expressly incorporated by reference in its entirety.

### BACKGROUND OF THE INVENTION

1. Field of the Invention

The present invention relates to a clothes dryer, and particularly, to a clothes dryer having a fragrance supplying module capable of spraying fragrance into a drum thereof.

2. Background of the Invention

In general, a clothes dryer indicates an apparatus for drying laundry having completely undergone a dehydration process after a washing process, by introducing the laundry into a drum of the clothes dryer, and by evaporating moisture inside the laundry by supplying hot blast into the drum.

The clothes dryer comprises a drum disposed in the clothes dryer and into which laundry is introduced, a driving motor for driving the drum, a blow fan for blowing air into the drum, and a heating means for heating the air introduced into the drum.

The heating means may use high-temperature electric resistance heat generated by using an electric resistance, or combustion heat generated by combusting gas.

Air having been discharged from the drum contains moisture of the laundry inside the drum, thereby changing into high-temperature humid air. According to a method for processing the high-temperature humid air, the clothes drier may be classified. More concretely, the clothes drier is classified into a condensation type clothes dryer for condensing moisture inside high-temperature humid air by heat-exchanging the high-temperature humid air with external air through circulation in the clothes dryer without discharging the high-temperature humid air out of the clothes dryer, and an exhaustion type clothes dryer for directly discharging high-temperature humid air having passed through the drum to the outside.

When drawing the laundry having completely undergone a drying process out of the clothes drier, it was required to supply a fresh feeling of the laundry to a user, and to remove wrinkles of the laundry. Accordingly, there have been needs to supply a fragrant material into the drum of the clothes drier during a drying process. Also, required is a means for easily supplementing the fragrant material supplied into the drum when the fragrant material is used up. Especially, required is a means for easily spraying a liquid fragrant material into the drum.

### SUMMARY OF THE INVENTION

Therefore, an object of the present invention is to provide a means capable of easily spraying a fragrant liquid into a drum of a clothes drier during a drying process, so as to supply fresh fragrance to laundry having been completely dried.

Another object of the present invention is to provide a fragrance supplying module capable of re-supplying a fragrant liquid to laundry when necessary, by being installed at a position to which a user can easily approach.

To achieve these and other advantages and in accordance with the purpose of the present invention, as embodied and broadly described herein, there is provided a clothes dryer having a fragrance supplying module, comprising: a body that forms appearance of the clothes dryer; a drum rotatably installed in the body; a front supporter for supporting the drum at a front side; and a rear supporter for supporting the drum at a rear side, wherein the fragrance supplying module for supplying fragrance into the drum is provided at the front supporter.

As the fragrance supplying module is provided at the front supporter, a fragrant liquid can be easily replaced by a new one or supplemented since a user's approach to the fragrance supplying module is facilitated.

The clothes dryer may further comprise a steam generator for supplying steam to the drum. Accordingly, the clothes dryer may supply both steam and fragrance to laundry.

The fragrance supply module may comprise a fragrance injection unit; a fragrance storage unit connected to the fragrance injection unit; a pump connected to the fragrance storage unit; and a nozzle connected to the pump by a tube, for spraying fragrance into the drum.

The fragrance injection unit may comprise a fixed member insertion-fixed to the front supporter, and a slide member slidably mounted to the fixed member.

Protrusions may be formed on both side surfaces of the slide member, and guide members for guiding the protrusions inserted thereto to slide may be formed at the fixed member.

A discharge opening may be formed at a lower part of the fixed member, and may be connected to the fragrance storage unit by a pipe. Accordingly, a fragrant liquid supplied from the fragrance injection unit is introduced into the fragrance storage unit through the pipe.

In the fragrance storage unit, may be disposed a level sensor for measuring an amount of a stored fragrant liquid. When the fragrant liquid is not sufficient, a user may be informed the state through the level sensor, thus to supplement the fragrant liquid.

Preferably, the fragrance injection unit may be installed at a side surface of the front supporter. And, an exit of the nozzle may be preferably installed at an upper part of the front supporter so as to be toward the inside of the drum.

The fragrance supplying module may comprise a cartridge detachably mounted to the front supporter 28 and containing fragrance therein; a pump connected to the cartridge; and a nozzle connected to the pump by a tube, for spraying fragrance into the drum. In the case that fragrance contained in the cartridge is used up, only the cartridge may be replace by a new one. To this end, a cartridge accommodation unit for accommodating the cartridge therein may be formed at the front supporter.

The clothes dryer according to the present invention is provided with a means for easily spraying a fragrant liquid into the drum disposed in the clothes dryer during a drying process. And, the fragrant liquid can be easily supplied to the fragrance supplying module. Since the fragrance supplying module is installed at a position to which a user can easily approach, it can be easily replaced by a new one, or can be easily repaired when necessary.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view of a clothes dryer according to the present invention;

FIG. 2 is a side sectional view of the clothes dryer of FIG. 1;

FIG. 3 is a perspective view of a steam generator of the clothes dryer;

FIG. 4 shows a mounting position of a fragrance supplying module at a front supporter, which is viewed from the front side of the clothes dryer;

FIG. 5 shows the fragrance supplying module mounted at the front supporter, which is viewed from the inside of the clothes dryer;

FIG. 6 is a perspective view of the fragrance supplying module;

FIG. 7 is a view showing that a slide member of a fragrance injection unit of the fragrance supplying module has been inserted into a fixed member; and

FIG. 8 is a view showing that the slide member of the fragrance injection unit of the fragrance supplying module has been drawn out of the fixed member by a sliding motion.

### DETAILED DESCRIPTION OF THE INVENTION

Description will now be given in detail of the present invention, with reference to the accompanying drawings.

Hereinafter, a clothes dryer having a fragrance supplying module according to the present invention will be explained in more detail.

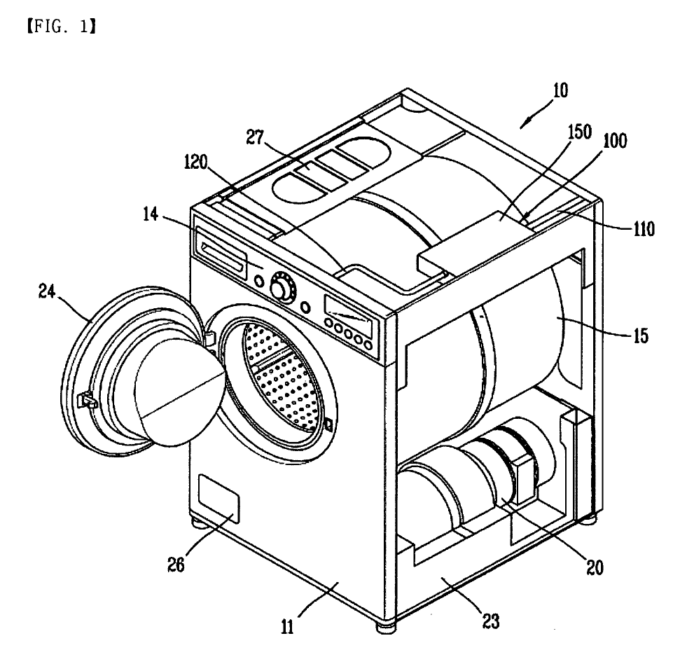

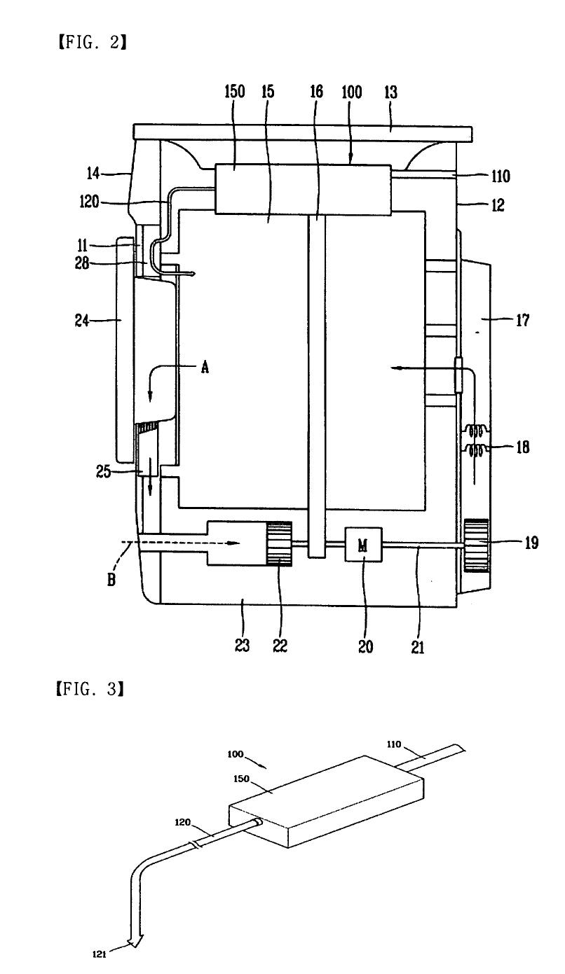

Referring to FIGS. 1 and 2, the clothes dryer 10 having a fragrance 10 supplying module according to the present invention comprises a front cover 11 that forms appearance thereof, a rear cover 12, a top cover 13, and a drum 15 into which laundry is introduced. A front supporter 28 of the clothes dryer 10 is mounted at a rear side of the front cover 11, and supports a front opening of the drum 15.

A door 24 for opening and closing the front opening of the drum 15 is provided at the front cover 11. And, a control panel 14 having each kind of buttons for inputting drying conditions is provided at an upper part of the front cover 11.

Also, the clothes dryer 10 comprises a drying fan 19 for making air inside the drum 15 circulate therein, a drying duct 17 for guiding circulation air having passed through the drying drum 15 to be introduced into the drum 15, a heater 18 disposed in the drying duct 17 for heating air introduced into the drum 15, and a steam generator 100 disposed at an outer side of the drum 15 for generating steam.

Below the drum 15, further comprised are a base 23 having a flow path of circulation air (A) and a flow path of external air (B) which performs heat exchange with the circulation air; a driving motor 20 mounted on an upper part of the base 23 for driving the drum 15; a belt 16 for transmitting a rotation force generated by the driving motor 20 to the drum 15; a cooling fan 22 connected to a motor shaft 21 of the driving motor 20 for sucking indoor air; and a condenser 26 mounted at an inner side of the base 23, for heat-exchanging the external air (B) with the circulation air (A).

FIG. 3 is a perspective view of a steam generator of the clothes dryer.

Referring to FIG. 3, the steam generator 100 includes a water supplying hose 110 for supplying water having a room temperature to a steam generator lo body 150, the steam generator body 150 for storing water supplied thereto, a heater (not shown) disposed in the steam generator body 150 for heating the stored water, a discharge hose 120 for discharging steam generated from the steam generator body 150, and a steam nozzle 121 connected to the end of the discharge hose 120. Under these configurations, water having been supplied to the steam generator body 150 through the water supplying hose 110 is heated by the heater, and then is discharged to the discharge hose 120. And, the discharged steam is sprayed into the drum 15 through the steam nozzle 121.

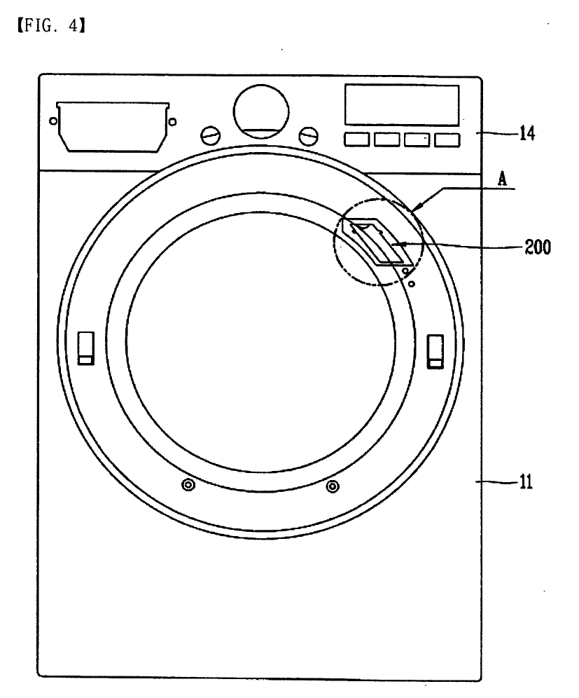

FIG. 4 shows a mounting position of a fragrance supplying module at a front supporter, which is viewed from the front side of the clothes dryer.

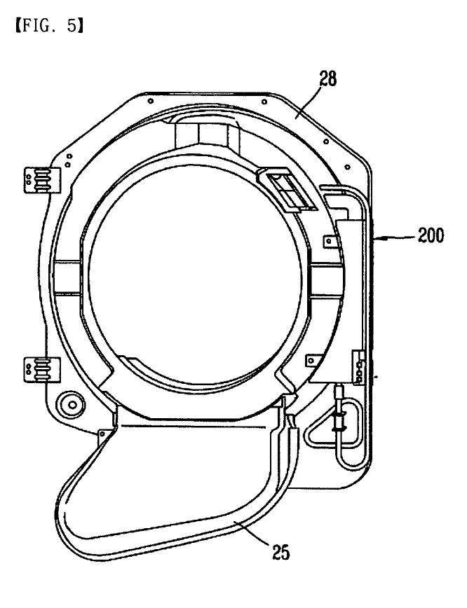

Referring to FIG. 4, the fragrance supplying module 200 is installed at a right part of the front supporter 28. In FIG. 4, the position of the front supporter 28 where the fragrance supplying module 200 is installed is merely exemplary. The fragrance supplying module 200 may be installed at a lower part or a left part (FIG. 5) of the front supporter 28.

FIG. 5 shows the fragrance supplying module 200 for supplying fragrance into the drum 15. And, FIG. 15 shows the shape of the front supporter 28 that supports the front opening of the drum 15, which is viewed from the inside of the clothes dryer. A filter 25 is mounted below the front opening of the drum 15, thereby filtering lint included in air discharged from the drum. The fragrance supplying module 200 is mounted at a side surface (left side in FIG. 5) of the front supporter 28.

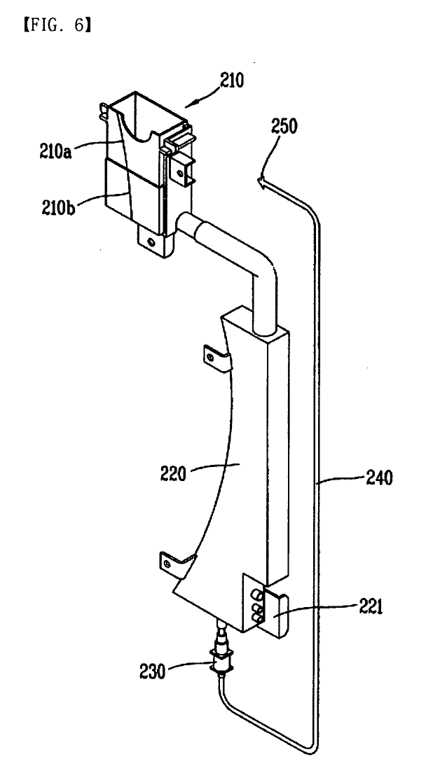

FIG. 6 is a disassembled perspective view of the fragrance supplying module of FIG. 5.

Referring to FIG. 6, the fragrance supply module 200 includes a fragrance injection unit 210, a fragrance storage unit 220 connected to the fragrance injection unit 210; a pump 230 connected to the fragrance storage unit 220; and a nozzle 250 connected to the pump 230 by a tube, for spraying fragrance into the drum 15.

The fragrance injection unit 210 is composed of a slide member 210a and a fixed member 210b. The fixed member 210b is fixedly mounted to the front supporter 28, and the slide member 210a is slidably mounted to the fixed member 210b. Protrusions 210aa are formed on both side surfaces of the slide member 210a, and guide members 210bb for guiding the protrusions 210aa inserted thereto to perform a sliding motion. Accordingly, the slide member 210a may be inserted into the fixed member 210b by a sliding motion, thereby being inserted into the front supporter 28.

A discharge opening is formed at a lower part of the fixed member 210b, and is connected to the fragrance storage unit 220. Under this configuration, when a user is to inject a fragrant liquid into the fragrance storage unit 220, the slide member 210a of the fragrance injection unit 210 is pulled to be protruding from the front supporter 28. Then, the fragrant liquid is injected into the slide member 210a for supplement.

In the fragrance storage unit 220, may be disposed a level sensor 221 for measuring the amount of a fragrant liquid stored in the fragrance storage unit 220. The level sensor 221 may be an electrode sensor, or a reed switch operated by a magnetic field generated from a permanent magnet and a current-carrying coil. The present invention may be also provided with a means for informing a user that the amount of fragrance inside the fragrance storage unit 220 is not sufficient. Preferably, the means is installed at a control panel disposed on a front surface of the clothes dryer.

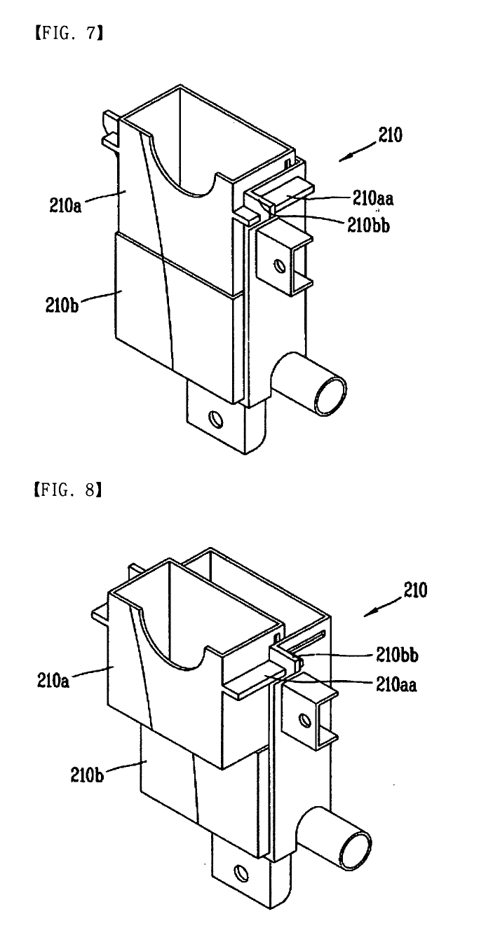

FIG. 7 is a view showing that the slide member 210a of the fragrance injection unit 210 has been inserted into the fixed member 210b, and FIG. 8 is a view showing that the slide member 210a of the fragrance injection unit 210 has been drawn out of the fixed member 210bby a sliding motion.

In the case of requiring no additional fragrant liquid while the clothes dryer performs a drying process, the slide member 210a is in an inserted state into the fixed member 210b, and the fixed member 210b is in an inserted state into the front supporter 28 as shown in FIG. 7. And, the fragrant liquid inside the fragrance storage unit 220 is sprayed into the drum 15.

However, in the case of requiring an additional fragrant liquid for supplement after the clothes dryer has performed drying processes a plurality of times, the slide member 210a of the fragrance injection unit 210 is drawn out of the fixed member 210. Accordingly, the fragrant liquid is injected into the slide member 210a for supplement.

According to a second embodiment of the present invention, the fragrance supplying module may comprise a cartridge detachably mounted to the front supporter 28 and containing fragrance therein; a pump connected to the cartridge; and a nozzle connected to the pump by a tube, for spraying fragrance into the drum. That is, instead of the fragrance injection unit 210 and the fragrance storage unit 220 of the first embodiment, a cartridge having fragrance filled therein is used in the second embodiment. In the case that fragrance filled in one cartridge is used up, the cartridge is replaced by a new cartridge. Accordingly, there is no need to inject fragrant liquid into the slide member 210a, again. Also, the cartridge may be detached from the clothes dryer to be supplemented with fragrant liquid. Then, the cartridge may be mounted to the front supporter 28, again. To this end, a cartridge accommodation unit for accommodating the cartridge therein may be formed at the front supporter 28.

Hereinafter, will be briefly explained a process for performing a drying process with spraying fragrance to the drum 15 inside the clothes dryer 10.

Firstly, a user opens the door 24 to put laundry into the drum 15, and then inputs a drying course with fragrance spray through an input unit mounted on the control panel 14. Once the drying process starts, the driving motor 20 is operated. And, the belt 16 wound on an outer circumferential surface of the drum 15 and the motor shaft 21 is rotated as the motor shaft 21 is rotated. Accordingly, the drum 15 is also rotated. Here, the cooling fan 22 and the drying fan 19 connected to the driving motor 20 are also driven, and the heater 18 mounted in the drying duct 17 heats air introduced into the drum 15.

In the case of requiring steam supply during the drying process, the steam generator 100 heats water therein by using the heater 18, thereby supplying steam into the drum 15. In the drying process of the present invention, a process for spraying fragrance into the drum 15 may be separately performed from the process for spraying steam into the drum 15.

In the present invention, a fragrant liquid injected into the fragrance injection unit 210 is stored in the fragrance storage unit 220. Then, the fragrant liquid is compressed by the pump 230 when necessary, thereby being sprayed into the drum 15 through the nozzle 250 in the form of mists. The time to spray the fragrant liquid may be manually controlled by a user's manipulation of the control panel, or may be automatically controlled by a microprocessor. In the case of the latter automatic control, a user selects his or her desired drying course among a plurality of pre-programmed drying courses on the control panel. According to the selected drying course, the time to spray the fragrant liquid is automatically controlled by a microprocessor.

Once the fragrant liquid stored in the fragrance storage unit 220 of the fragrance supplying module 200 is used up after the clothes dryer has performed drying processes a plurality of times, the level sensor implemented as an electrode sensor or a magnetic sensor for measuring the amount of the fragrant liquid inside the fragrance storage unit 220 detects the insufficient state of the fragrant liquid. As the level sensor transmits the information to the microprocessor, the microprocessor may generate a signal informing the insufficient state of the fragrant liquid to a user. In order to inject fragrant liquid into the fragrance supplying module 200 for supplement, the user opens the door to pull the slide member 210a of the fragrance injection unit 210 installed at the front supporter 28. Accordingly, the slide member 210a is drawn out of the fixed member 210b. Under this state, the user injects fragrant liquid into the slide member 210a. In the case of using a cartridge having fragrance filled therein instead of the fragrance injection unit and the fragrance storage unit, the cartridge having completely-used fragrance is separated from the clothes dryer. Then, the cartridge is supplemented with fragrant liquid, and is mounted to the front supporter 28, again. Alternatively, the cartridge may be replace by a new one.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A clothes dryer, comprising:
a body that forms appearance of the clothes dryer;
a drum rotatably installed in the body;
a front supporter for supporting the drum at a front side; and
a fragrance supplying module provided at the front supporter, for supplying fragrance into the drum.

2. The clothes dryer of claim 1, wherein the fragrance supplying module comprises:
a fragrance storage unit for storing fragrant liquid; and
a fragrance injection unit for injecting fragrant liquid.

3. The clothes dryer of claim 2, wherein the fragrance supplying module further comprises:
a pump connected to the fragrance storage unit; and
a nozzle connected to the pump by a tube, for spraying fragrance into the drum.

4. The clothes dryer of claim 3, wherein the fragrance injection unit comprises:
a fixed member insertion-fixed to the front supporter; and
a slide member slidably mounted to the fixed member.

5. The clothes dryer of claim 4, wherein protrusions are formed on both side surfaces of the slide member, and guide members for guiding the protrusions inserted thereto to slide are formed at the fixed member.

6. The clothes dryer of claim 4, wherein a discharge opening is formed at a lower part of the fixed member, and is connected to the fragrance storage unit.

7. The clothes dryer of claim 3, wherein the fragrance storage unit is provided with, therein, a level sensor for measuring an amount of a fragrant liquid stored in the fragrance storage unit.

8. The clothes dryer of claim 3, wherein the fragrance injection unit is installed at a side surface of the front supporter.

9. The clothes dryer of claim 3, wherein an exit of the nozzle is installed at an upper side of the front supporter so as to be toward inside of the drum.
